(19) United States
(12) Patent Application Publication
(10) Pub. No.: US 2026/0343361 A1
(43) Pub. Date: Oct. 29, 2026

(54) ENHANCEMENTS TO BEAM MANAGEMENT

(71) Applicant: Nokia Technologies Oy, Espoo (FI)

(72) Inventors: Srinivasan SELVAGANAPATHY, Bangalore (IN); Ahmad AWADA, Munich (DE); Amaanat ALI, Espoo (FI); Panagiotis SPAPIS, Munich (DE); Subramanya CHANDRASHEKAR, Bangalore (IN)

(21) Appl. No.: 18/998,945

(22) PCT Filed: Jun. 28, 2023
(86) PCT No.: PCT/EP2023/067677

§ 371 Date: Jan. 27, 2025

(30) Foreign Application Priority Data
Jul. 28, 2022 (IN) 202241043261

(51) Int. Cl. H04W 36/08; H04W 36/00

(52) U.S. Cl. CPC H04W 36/085; H04W 36/0058

(57) ABSTRACT

Described herein is a user equipment (UE) configured for supporting inter-cell beam management (ICBM) involving a plurality of cells which includes a source cell serving the UE and at least one neighboring target cell, wherein the UE comprises: at least one processor; and at least one memory storing instructions that, when executed by the at least one processor, cause the UE at least to: send a measurement report comprising information indicative of a target cell of the at least one neighboring target cell to a first network node that supports at least one of central unit control plane (CU-CP) functionality or a layer 3 protocol of a radio access network; and receive, from the first network node, a configuration message comprising information indicative of a channel state information (CSI) measurement related configuration, wherein the CSI measurement related configuration comprises a CSI resource related configuration that is commonly used for measurement at cells involved in the ICBM and a cell-specific CSI report related configuration for a subset of the cells, wherein the subset is determined depending on the source cell, and wherein the subset includes the source cell and at least one target cell.

### TECHNOLOGY

The present disclosure relates to beam management, in particular to enhancements to beam measurement and/or beam management configuration for inter-cell mobility.

### BACKGROUND

Any discussion of the background art throughout the specification should in no way be considered as an admission that such art is widely known or forms part of common general knowledge in the field.

Broadly speaking, in some existing mobile communication techniques, beam switching/changing may comprise the steps of: CSI (channel state information) reporting from a UE (user equipment) about configured CSI resources; and TCI (transmission configuration indication) state changing for the control channel (such as Physical Downlink Control Channel or PDCCH for short) and the data channel (such as Physical Downlink Shared Channel or PDSCH for short) based on CSI report configuration.

Beam measurement report may be generally classified into two main categories, namely:
CSI report related to PMI (precoding matrix index) and also PDSCH specific RSs (reference signals), which is meant for beam refinement and MIMO (multiple-input and multiple-output) operation and only CSI-RS resources are used for this purpose; and
CSI report for beam switching, which generally involves CSI resource indicator and RSRP (reference signal received power) reports of selected resources and may also be applicable to SSB (synchronization signal block) of beams.

Further, beam switching is generally triggered by TCI state change operation. In addition, beam switching for control channel and beam switching/refinement for PDSCH also happens based on the TCI state change. These two types are generally summarised as follows:
PDCCH TCI state change:
   to switch the control channel beam due to UE mobility,
   MAC command (e.g., MAC control element (CE)) indicating switching of TCI state for CORESET (control resource set); and
PDSCH TCI state change:
   set of TCI states for PDSCH configured for beam refinement and MIMO operation,
   TCI set is selected via MAC CE, and
   TCI state within set is indicated via PDCCH.

With the development of technology, the beam management operation may be extended across multiple cells, which, in some cases, is also referred to as inter-cell beam management (ICBM). Thus, there is a need to support such beam management (e.g., dynamic beam switching or ICBM) in an efficient and flexible manner.

### SUMMARY

In accordance with an aspect of the present disclosure, there is provided a user equipment (UE) configured for supporting inter-cell beam management (ICBM) involving a plurality of cells which includes a source cell serving the UE and at least one neighboring target cell, wherein the UE comprises:
at least one processor; and
at least one memory storing instructions that, when executed by the at least one processor, cause the UE at least to:
   send a measurement report comprising information indicative of a target cell of the at least one neighboring target cell to a first network node that supports at least one of central unit control plane (CU-CP) functionality or a layer 3 (L3) protocol of a radio access network; and
   receive, from the first network node, a configuration message comprising information indicative of a channel state information (CSI) measurement related configuration, wherein the CSI measurement related configuration comprises a CSI resource related configuration that is commonly used for measurement at cells involved in the ICBM and a cell-specific CSI report related configuration for a subset of the cells, wherein the subset is determined depending on the source cell, and wherein the subset includes the source cell and at least one the target cell.

In some examples, the UE is further caused to:
perform a measurement based on the CSI measurement related configuration; and
report a result of the measurement to a second network node of the source cell that supports at least one of distributed unit (DU) functionality or the layer 2 (L2) protocol of the radio access network based on the CSI report related configuration corresponding to the source cell.

In some examples, the UE is further caused to receive, from the second network node of the source cell, a message indicative of a transmission configuration indication (TCI) state corresponding to the target cell, for switching the UE to a beam of the target cell indicated by the TCI state.

In some examples, the UE is further caused to switch control channel monitoring from the source cell to the target cell.

In some examples, the UE is further caused to perform a measurement based the CSI measurement related configuration, and report a result thereof to a second network node of the target cell that supports at least one of distributed unit (DU) functionality or the layer 2 (L2) protocol of the radio access network based on the CSI report related configuration corresponding to the target cell.

In some examples, the UE is further caused to receive, from the second network node of the target cell, a message indicative of a TCI state corresponding to the source cell, for switching the UE back to a beam of the source cell indicated by the TCI state.

In some examples, the second network node of the source cell and the second network node of the target cell are different network nodes

In some examples, the CSI resource related configuration commonly used for measurements at cells is for beam switching; and wherein the CSI measurement related configuration further comprises a cell-specific CSI resource related configuration for beam refinement for the subset of cells.

In some examples, the configuration message further comprises a control channel related TCI state configuration that is commonly referred to in cells involved in the ICBM and a cell-specific data channel related TCI state configuration for the subset of cells.

In some examples, the configuration message further comprises a cell-specific bitmap associated with the cell-specific CSI report related configuration for the subset of cells.

In some examples, the configuration message is a radio resource control (RRC) reconfiguration message.

In accordance with another aspect of the present disclosure, there is provided a first network node that supports at least one of central unit control plane (CU-CP) functionality or a layer 3 (L3) protocol of a radio access network, configured for supporting inter-cell beam management (ICBM) involving a plurality of cells which includes a source cell serving a user equipment (UE) and at least one neighboring target cell, wherein the first network node comprises:
at least one processor; and
at least one memory storing instructions that, when executed by the at least one processor, cause the first network node at least to:
   receive, from the UE, a measurement report comprising information indicative of a target cell of the at least one neighboring target cell;
   generate a configuration message comprising information indicative of a channel state information (CSI) measurement related configuration, wherein the CSI measurement related configuration comprises a CSI resource related configuration that is commonly used for measurement at cells involved in the ICBM and a cell-specific CSI report related configuration for a subset of the cells, wherein the subset is determined depending on the source cell, and wherein the subset includes the source cell and at least one target cell; and
   send the configuration message to the UE.

In some examples, the first network node is further caused to:
transmit a first request message comprising information indicative of ICBM to a second network node of the source cell that supports at least one of distributed unit (DU) functionality or the layer 2 (L2) protocol of the radio access network; and
receive, from the second network node of the source cell, a first response message comprising information indicative of the CSI resource related configuration.

In some examples, the first network node is further caused to:
transmit a second request message comprising information indicative of ICBM and information indicative of the CSI resource related configuration to a second network node of the target cell that supports at least one of distributed unit (DU) functionality or the layer 2 protocol of the radio access network; and
receive, from the second network node of the target cell, a second response message comprising information indicative of CSI measurement related configuration for the target cell.

In some examples, the first network node is further caused to:
transmit a third request message comprising information indicative of the CSI measurement related configuration for the target cell to the second network node of the source cell; and
receive, from the second network node of the source cell, a third response message comprising information indicative of the CSI measurement related configuration modified based on the information indicative of the CSI measurement related configuration for the target cell.

In some examples, the first and second request messages are each a respective UE context setup request message; and the first and second response messages are each a respective UE context setup response message.

In some examples, the third request message is a UE context modification request message; and the third response message is a UE context modification response message.

In some examples, the CSI resource related configuration commonly used for measurements at cells is for beam switching; and wherein the CSI measurement related configuration further comprises a cell-specific CSI resource related configuration for beam refinement for the subset of cells.

In some examples, the configuration message further comprises a control channel related transmission configuration indication (TCI) state configuration that is commonly referred to in cells involved in the ICBM and a cell-specific data channel related TCI state configuration for the subset of cells.

In some examples, the configuration message further comprises a cell-specific bitmap associated with the cell-specific CSI report related configuration for the subset of cells.

In some examples, the configuration message is a radio resource control (RRC) reconfiguration message.

In accordance with yet another aspect of the present disclosure, there is provided a second network node that supports at least one of distributed unit (DU) functionality or a layer 2 (L2) protocol of a radio access network, configured for supporting inter-cell beam management (ICBM) involving a plurality of cells which includes a source cell of the second network node serving a user equipment (UE) and at least one neighboring target cell, wherein the second network node comprises:
at least one processor; and
at least one memory storing instructions that, when executed by the at least one processor, cause the second network node at least to:
   receive, from a first network node that supports at least one of central unit control plane (CU-CP) functionality or the layer 3 (L3) protocol of the radio access network, a first request message comprising information indicative of a channel state information (CSI) measurement related configuration for a target cell of the at least one neighboring target cell;
   generate a first response message comprising information indicative of a CSI measurement related configuration modified based on the received information indicative of the CSI measurement related configuration for the target cell, wherein the CSI measurement related configuration comprises a CSI resource related configuration that is commonly used for measurement at cells involved in the ICBM and a cell-specific CSI report related configuration for a subset of the cells, wherein the subset is determined depending on the source cell, and wherein the subset includes the source cell and at least one target cell; and
   send the first response message to the first network node.

In some examples, the second network node is further caused to:
receive, from the first network node, a second request message comprising information indicative of ICBM; and
transmit a second response message comprising information indicative of the CSI resource related configuration to the first network node.

In some examples, the second network node is further caused to transmit a configuration message that comprises information indicative of transmission configuration indication (TCI) state information for the cells involved the ICBM.

In some examples, the second network node is further caused to:
receive, from the UE, a report of a measurement performed based on the CSI report related configuration corresponding to the source cell; and
transmit a configuration message that comprises information indicative of TCI state information for another subset of the cells involved the ICBM, wherein the another subset of the cells is determined based on the target cell.

In some examples, the second network node is further caused to transmit a message indicative of a transmission configuration indication (TCI) state corresponding to the target cell to the UE, for switching the UE to a beam of the target cell indicated by the TCI state.

In some examples, the first request message is a UE context modification request message; and the first response message is a UE context modification response message.

In some examples, the second request message is a UE context setup request message; and the first response message is a UE context setup response message.

In accordance with yet another aspect of the present disclosure, there is provided a method of a user equipment (UE) configured for supporting inter-cell beam management (ICBM) involving a plurality of cells which includes a source cell serving the UE and at least one neighboring target cell, the method comprising:
sending a measurement report comprising information indicative of a target cell of the at least one neighboring target cell to a first network node that supports at least one of central unit control plane (CU-CP) functionality or a layer 3 (L3) protocol of a radio access network; and
receiving, from the first network node, a configuration message comprising information indicative of a channel state information (CSI) measurement related configuration, wherein the CSI measurement related configuration comprises a CSI resource related configuration that is commonly used for measurement at cells involved in the ICBM and a cell-specific CSI report related configuration for a subset of the cells, wherein the subset is determined depending on the source cell, and wherein the subset includes the source cell and at least one target cell.

In accordance with yet another aspect of the present disclosure, there is provided a method of a first network node that supports at least one of central unit control plane (CU-CP) functionality or a layer 3 (L3) protocol of a radio access network, configured for supporting inter-cell beam management (ICBM) involving a plurality of cells which includes a source cell serving a user equipment (UE) and at least one neighboring target cell, the method comprising:
receiving, from the UE, a measurement report comprising information indicative of a target cell of the at least one neighboring target cell;
generating a configuration message comprising information indicative of a channel state information (CSI) measurement related configuration, wherein the CSI measurement related configuration comprises a CSI resource related configuration that is commonly used for measurement at cells involved in the ICBM and a cell-specific CSI report related configuration for a subset of the cells, wherein the subset is determined depending on the source cell, and wherein the subset includes the source cell and at least one target cell; and
sending the configuration message to the UE.

In accordance with yet another aspect of the present disclosure, there is provided a method of a second network node that supports at least one of distributed unit (DU) functionality or a layer 2 (L2) protocol of a radio access network, configured for supporting inter-cell beam management (ICBM) involving a plurality of cells which includes a source cell of the second network node serving a user equipment (UE) and at least one neighboring target cell, the method comprising:
receiving, from a first network node that supports at least one of central unit control plane (CU-CP) functionality or the layer 3 (L3) protocol of the radio access network, a first request message comprising information indicative of a channel state information (CSI) measurement related configuration for a target cell of the at least one neighboring target cell;
generating a first response message comprising information indicative of a CSI measurement related configuration modified based on the received information indicative of the CSI measurement related configuration for the target cell, wherein the CSI measurement related configuration comprises a CSI resource related configuration that is commonly used for measurement at cells involved in the ICBM and a cell-specific CSI report related configuration for a subset of the cells, wherein the subset is determined depending on the source cell, and wherein the subset includes the source cell and at least one target cell; and
sending the first response message to the CU.

Furthermore, according to some example embodiments, there is provided a UE comprising respective suitable means configured for performing the respective steps as disclosed in the present disclosure.

Similarly, according to some example embodiments, there is also provided a CU and a DU comprising respective suitable means configured for performing the respective steps as disclosed in the present disclosure.

In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

While some example embodiments will be described herein with particular reference to the above application, it will be appreciated that the present disclosure is not limited to such a field of use, and is applicable in broader contexts.

Notably, it is understood that methods according to the present disclosure relate to methods of operating the apparatuses according to the above example embodiments and variations thereof, and that respective statements made with regard to the apparatuses likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processor, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

Other and further example embodiments of the present disclosure will become apparent during the course of the following discussion and by reference to the accompanying drawings.

### BRIEF DESCRIPTION OF THE DRAWINGS

Example embodiments of the disclosure will now be described, by way of example only, with reference to the accompanying drawings in which:

FIG. 1 schematically illustrates an example of a high level block diagram of a CSI (channel state information) measurement(-related) configuration according to an example embodiment of the present disclosure;

FIG. 2 schematically illustrates an example of a signaling/messaging flowchart according to an example embodiment of the present disclosure;

FIG. 3 schematically illustrates an example of a high level block diagram of a CSI (channel state information) measurement(-related) configuration according to another example embodiment of the present disclosure;

FIG. 4 schematically illustrates an example of a high level block diagram of a modified TCI (transmission configuration indication) state configuration according to an example embodiment of the present disclosure; and

FIG. 5 schematically illustrates an example of a signaling/messaging flowchart according to another example embodiment of the present disclosure.

### DESCRIPTION OF EXAMPLE EMBODIMENTS

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele)communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0 (2021-06) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the El interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the El interface connected with the gNB-CU-CP and the F1-U interface connected with the gNB-DU, e.g., according to 3GPP TS 38.401 V16.6.0 (2021-07) section 3.1 incorporated by reference.

Different functional splits between the central and distributed unit are possible, e.g., called options:

### Option 1 (1A-Like Split):

The function split in this option is similar to the 1A architecture in DC. RRC is in the central unit. PDCP, RLC, MAC, physical layer and RF are in the distributed unit.

### Option 2 (3C-Like Split):

The function split in this option is similar to the 3C architecture in DC. RRC and PDCP are in the central unit. RLC, MAC, physical layer and RF are in the distributed unit.

### Option 3 (Intra RLC Split):

Low RLC (partial function of RLC), MAC, physical layer and RF are in the distributed unit. PDCP and high RLC (the other partial function of RLC) are in the central unit.

### Option 4 (RLC-MAC Split):

MAC, physical layer and RF are in the distributed unit. PDCP and RLC are in the central unit.

Or else, e.g., according to 3GPP TR 38.801 V14.0.0 (2017-03) section 11 incorporated by reference.

A gNB supports different protocol layers, e.g., Layer 1 (L1)-physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L 3) includes e.g., Radio Resource Control (RRC), e.g., according to 3GPP TS 38.300 V16.6.0 (2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0(2021 -06) sections 42.1 and 4.4, incorporated by reference).

A UE is e.g., either in RRC_CONNECTED state or in RRC_INACTIVE state when an RRC connection has been established.

In RRC CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

The general functions and interconnections of the described elements and functions, which also depend on the actual network type, are known to those skilled in the art and described in corresponding specifications, so that a detailed description thereof may omitted herein for the sake of conciseness. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station/BS, a gNB, a radio network controller, a core network control element or function, such as a gateway element, or other network elements or functions, as described herein, and any other elements, functions or applications may be implemented by software, e.g., by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors. It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

As illustrated above, the present disclosure generally seeks to provide an efficient and flexible beam management mechanism for supporting e.g. (dynamic) beam switching or ICBM use cases.

According to a broad aspect, the idea of ICBM may be generally understood as making use of a so-called “borrowed” beam of a (target) cell different from the source/serving cell. The (target) cell may be of (operated by) the same serving DU of the source/serving cell or a different DU other than the serving DU, which may thus, in some cases, be referred to as intra-DU ICBM or inter-DU ICBM, respectively. In some possible cases, a UE may be connected to a serving DU and while traveling through the cell, it may experience good measurement results from another cell (e.g., of another DU) which may be a coverage island inside the serving cell or an overlapping area with a serving cell (e.g., at serving cell edge). The connection with the serving cell may for example be still good, but the connection to the other cell is/becomes better. In that case, UE may be served by the borrowed beam (“borrowed” in the sense that UE may be indicted to communicate with a beam from another cell without the serving cell change) of the non-serving DU without performing a complete (conventional) handover to another cell, and hence no additional RRC signaling overhead and interruption time compared to (conventional) handover are observed.

When beam management is to be extended for ICBM operations, CSI (channel state information) measurement configuration and TCI (transmission configuration indication) states for PDCCH and PDSCH would have to be modified to include the target cell(s) that is/are close by or neighboring the current serving cell of the UE. Notably, unless indicated otherwise, in the context of the present disclosure, the CSI measurement(-related) configuration may be generally divided/classified into, among others, two sets of (sub-)configuration, namely: a set of configuration that relates to CSI resource configuration (e.g., specifying on what type of reference signal is to be transmitted) and another set of configuration that relates to CSI report/reporting configuration (e.g., relating to the configuration of reporting behavior of the CSI, such as periodic, semi-persistent or aperiodic reporting, etc.). However, as can be understood and appreciated by the skilled person, the CSI measurement(-related) configuration may include any other suitable configuration as well, depending on various implementations and/or requirements.

Specifically, the following problems may be envisaged when the above-mentioned configurations are to be expanded to include resources of multiple cells (which may include, depending on various implementations, a source cell currently serving the UE, and in addition, one or more target cells neighboring the serving cell of the UE that are configured for supporting the ICBM operations).

Firstly, if the CSI reporting related configuration is maintained as common across the cells associated with ICBM, the target cell(s) may need to reserve resources at the same location for example in the control channel (such as PUCCH) and/or data channel (such as PUSCH) for reporting, which may impact the current scheduling at the target cell(s).

Secondly, expanding the configuration to include all possible configurations of target cell(s) would appear to be redundant from signaling point of view, and as a result, create overhead from UE perspective.

Thirdly, modification of beam management related configuration to enable efficient beam switching operation without impacting cell specific beam refinement operation within the same cell appears to also need consideration.

In view thereof, the present disclosure generally proposes apparatuses (such as UE, DU, CU, or the like) as well as corresponding methods to address some or all of the above-illustrated remarks, particularly in an efficient and flexible manner. Particularly, in a broad sense, it may be seen that the present disclosure generally seeks to propose solutions to identify for example CSI resource and/or CSI reporting configuration applicable for one or more specific cells within the CSI measurement configuration for selective use of “subset of resource/report” depending particularly on the current serving cell.

Before going into detail of the example embodiments of the present disclosure, it may also be worthwhile to provide a brief description-from a high/abstract level perspective-that could serve as a basis for understanding possible underlying technologies (and the terminologies used therein) that are described in the present disclosure. However, as has been indicated above, the techniques described in the present disclosure may be applicable to some other possible technologies, for example with suitable/appropriate adaptation wherever necessary, as can be understood and appreciated by the skilled person.

In particular, as has been illustratively described above, within the technical context of radio network architecture for New Radio (NR), a gNB which is a radio network controller component of the NR/5G system may be implemented in two (separate) units generally known as central unit (CU) and distribution unit (DU). More particularly, a CU generally handles the higher layer functionality of radio interface such as radio resource signaling and radio resource management (RRM). Further, for user plane (UP), higher layers such as PDCP may also be hosted in this unit. On the other hand, a DU generally handles the lower layer functionality including for example radio link control (RLC) and medium access control (MAC) as well as physical layer functions. Particularly, a DU may support lower layer handling for multiple (i.e., more than one) NR cells depending on various implementations and/or requirements, and a UE is generally not aware of the difference between cells of the same DU or of different DUs.

(Conventional) techniques related to serving cell change (SCC) may include, but are not limited to, (regular) handover procedure and SCC using lower layer mobility. In particular, the procedure of SCC using lower layer mobility is generally considered similar to handover or conditional handover with the difference that the handover execution typically happens based on L1 measurements. In contrast, in the case of SCC using lower layer mobility, “handover” (from the serving cell to the target cell) execution is based on MAC CE from the serving DU which contains TCI state change information/indication corresponding to the target cell whose configuration is already provided by higher layer for execution. In addition, similar to the regular (high-layer-involved) handover procedure, MAC and RLC layers would need to be reset to restart the operation at respective layers. Further, in such case, the UE may need to apply the target cell configuration over the current cell configuration, and, after applying the new configuration, further to trigger a random access procedure if this reconfiguration would require synchronized use of new configuration.

By contrast, in ICBM there is generally no target cell configuration and handover preparation involved. Rather, the target cell provides “assistance cell” operation(s) and generally acts as an extended (“borrowed”) beam for the serving cell. As a result, when the UE changes to the new cell beam, the UE generally only switches the TCI state, and thus, there is no need for the UE to modify its RRC configuration during the beam switch. In addition, higher layer data transmissions are also un-affected, i.e., no reset of MAC and RLC layers is needed. Nevertheless, it is to be noted that, as the L1 measurement results are typically based on instantaneous measurements, the ICBM procedure would also allow for returning back to the source cell in a seamless manner similar to the (conventional) intra-cell beam management procedure. Thus, in some cases, the ICBM may also be referred to as dynamic switching ICBM or simply dynamic switching.

Furthermore, regarding ICBM and more particularly the relevance for inter-DU communication, it is noted that, as illustrated above, ICBM generally extends the (conventional) beam management mechanism which exists within the same cell (i.e., intra-cell beam management) to enable the use of neighboring cell beams also for beam management operation. Hereinafter, these (neighboring) cells are generally referred to as target cells in the present disclosure, unless indicated otherwise. Specifically, as illustrated above, ICBM may be limited to cells of the same DU, or depending on various implementations and/or requirements, also be extended to cells of other DU(s), which may be classified as intra-DU (i.e., within the same DU) ICBM and inter-DU (i.e., involving multiple DUs) ICBM respectively.

References are now made to the figures. In particular, it is to be noted that identical or like reference numbers used in the figures of the present disclosure may, unless indicated otherwise, indicate identical or like elements, such that repeated description thereof may be omitted for reasons of conciseness.

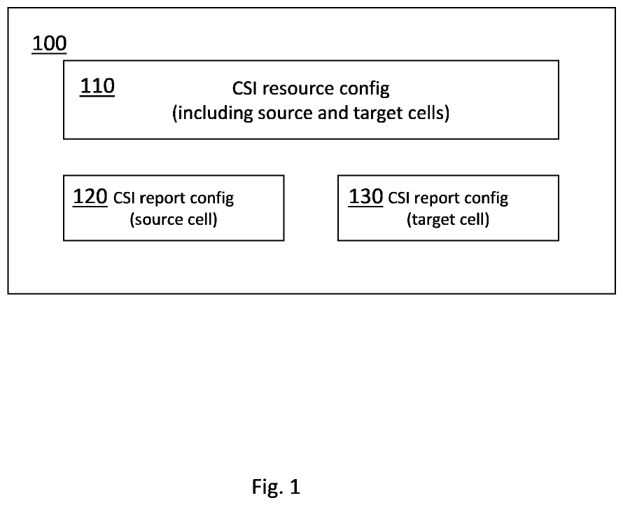

FIG. 1 schematically illustrates an example of a high-level block diagram of a (modified) CSI (channel state information) measurement(-related) configuration according to an example embodiment of the present disclosure. For example, in some possible implementations, the block diagram may represent a configuration that could be used (e.g., as part of an information element/IE) to be communicated between various network elements (e.g., CU, DU, UE, etc.) in some high-level messaging (e.g., as part of an RRC (radio resource control) reconfiguration message, or the like).

In a broad sense, the example embodiment as shown in FIG. 1 may generally be seen as to implement a (modified as compared to existing techniques) CSI measurement configuration that comprises a common CSI resource-related configuration and cell-specific CSI report-related configuration.

Particularly, as represented in FIG. 1, the exemplary (overall) CSI measurement configuration 100 comprises a CSI resource related configuration 110 that is commonly used for measurement at cells (all or a subset thereof) involved in the ICBM procedure. In addition, the CSI measurement configuration 100 also comprises a cell-specific CSI report/reporting related configuration for a subset of the cells. In some possible implementations, the cells in the subset may be determined (e.g., by the CU) depending on the (current) source cell, e.g., based on the overall topology of the cells, configurations (e.g., operational) of the cells, cells neighboring the current source cell, etc. In other words, when the UE is served by a new cell (e.g., due to mobility or beam switching), the subset of the cells for preparing/generating the CSI report related configuration may be determined based on the new source/serving cell (rather than the previous one). The subset may include, among other possible/potential cells also involved in the ICBM procedure, at least the source cell 120 and at least one (potential) target cell(s) 130, depending on various implementations. Notably, by the provision of different report configurations for the source cell and the target cell(s), generally speaking, the target cell(s) could be configured with (cell specific) report configurations different from that of the source cell (e.g., different uplink resources). In other words, the target cell(s) does not necessarily need to maintain a common CSI reporting related configuration across the cells associated with the ICBM, thereby avoiding possible impact on the current scheduling at the target cell(s).

As can be understood and appreciated by the skilled person, generally speaking, the term CSI resource related configuration may be seen as to specify on what type of reference signal the UE should measure and include in CSI report is to be transmitted. Thus, in some possible implementations, the CSI resource-related configuration may also be referred to as CSI-RS (reference signal) resource(-related) configuration. It may also configure the types of the transmission (e.g., periodic, aperiodic, or semi-persistent). On the other hand, the term CSI report configuration may be seen as to specify which CSI RS resources from the configured resource-set are measured and reported. CSI-Report configuration may also include the uplink resource configuration on how the CSI report to be delivered to base station. Typically, there is also defined a mapping table between the measurement type and the corresponding CSI resource config identification (ID). In addition, the CSI report configuration may also provide other suitable configuration/parameter(s) for, e.g., codebook configuration, time-domain behavior, frequency granularity for CQI and PMI, measurement restriction configurations, and the CSI-related quantities to be reported by the UE such as the layer indicator (L1), L1-RSRP, etc.

Notably, in the example embodiment as shown in FIG. 1, it is generally assumed that only two cells (i.e., denoted as the source cell and the target cell) are present for the operation of ICBM. However, as can be understood and appreciated by the skilled person, in some other possible implementations, more cells may be present for the ICBM as well, which may include (but is certainly not limited thereto), a source cell and one or more (potential) target cells. In such cases, the cells do not necessarily need to be named as “source” or “target”, but may be simply referred to by using numeric, such as cell 1, cell 2, cell 3, or the like. Thus, depending on various implementations and/or requirements, there may be more than one instance of such cell-specific CSI report configuration for the target cell 130. Certainly, in some other possible implementations, a single instance of the cell-specific CSI report configuration for the target cell 130 as shown in FIG. 1 may itself comprise all the necessary information for all the target cells, as can be understood and appreciated by the skilled person.

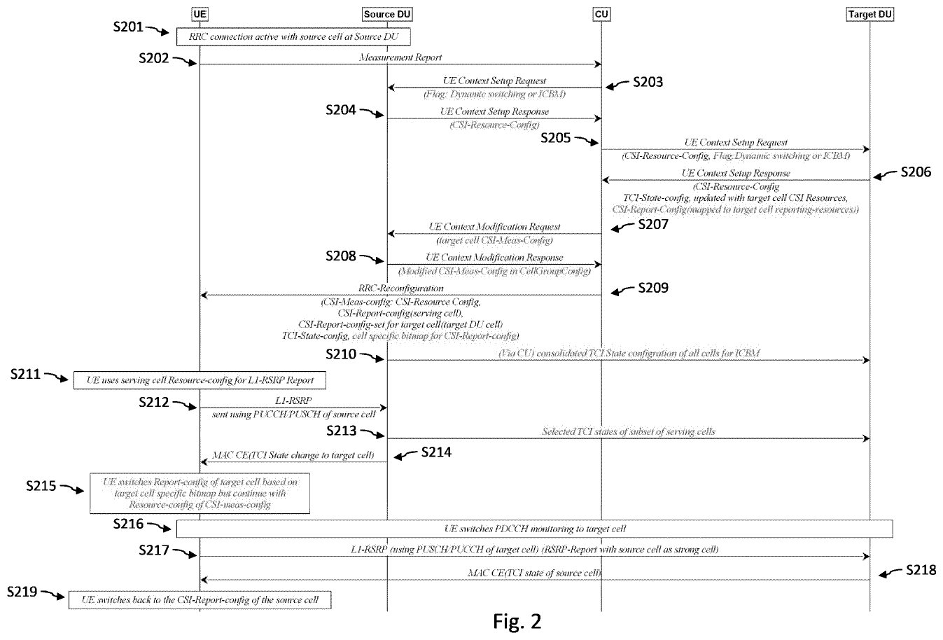

Now, a message sequence of the signaling procedure to activate cell specific report configuration along with TCI state management within the network will be described in more detail below with reference to FIG. 2. Particularly, it is to be noted that, in the example embodiment as shown in FIG. 2, it is generally assumed that the source cell resides at the source DU (or in other words, under the control of the source DU), whilst the (neighboring) target cell resides at the target DU (or in other words, under the control of the target DU). In some cases, the source cell/DU may also be referred to as serving cell/DU, as can be understood and appreciated by the skilled person. However, as has been illustrated above, the deployment of the source/target cells and/or the source/target DUs does not necessarily always have to be like this. For instance, in some possible implementations, both the source cell and the target cell may be under the control of the source DU alone. Certainly, any other suitable configuration may be possible as well (with appropriate adaptation to the signaling/messaging of course) depending on various implementations and/or requirements, as can be understood and appreciated by the skilled person.

Broadly speaking, in steps S201-S205, the UE is connected (as exemplarily indicated in step S201 as “RRC connection active”) to a source cell (or simply referred to as cell 1, not explicitly shown in the figure) which is under the control of the source DU and reports (among others) a target cell (or simply referred to as cell 2) in its measurements to the CU (step S202). In response, the CU fetches the CSI resource configuration from the source DU (e.g., by sending a UE context setup request message as shown in step S203, or by using any other suitable means) and forwards it to the target DU (where the target cell resides) with a flag indicative of “dynamic switching” or “ICBM” (step S205) once a corresponding response message (e.g., a UE context setup response message as shown in step S204 or the like) is received. As can be understood and appreciated by the skilled person, the flag may be implemented by using any suitable manner, e.g., as a (new or existing) field, as an entry in a lookup table (LUT), as a predefined/predetermined parameter, or the like. Thus, any suitable flag, e.g., other than those exemplified above (i.e., “dynamic switching” or “ICBM”), may be used. Furthermore, it may be worth mentioning that, in some possible implementations, the term “dynamic switching” (or sometimes also the term “ICBM”) may generally imply the possibility of the UE switching its operation (of the beam) from the source cell (current serving cell) to a neighboring target cell back and forth, depending on various circumstances and/or criteria (e.g., received signal power before and after the beam switching, etc.).

Subsequently, in steps S205-S206, the target DU (e.g., upon reception of another UE context setup request message as shown in step S205 or any other suitable message) merges the CSI resource config corresponding to the target cell (that is prepared by the target DU for ICBM) into the received CSI resource config provided by source DU. The target DU also generates (e.g., by appending or using any other suitable manner) the reporting configuration of CSI being mapped to the target cell and sends the same to the CU (e.g., in a corresponding context setup response message as shown in step S206 or any other suitable message).

Further, in step S207-S208, the CU updates the source DU with the modified CSI measurement configuration which has been updated by the target DU as illustrated earlier. This may be achieved for example by the exchange of a pair of UE context modification request and response messages as exemplified between the CU and the source DU in FIG. 2, or in any other suitable manner.

In step S209, the CU prepares an RRC reconfiguration message (or any other suitable message depending on various implementations) with a cell specific bitmap that points to the cell specific configurations for each of the source cell and the target cell. Certainly, as can be understood and appreciated by the skilled person, any other suitable implementation (e.g., other data format/structure than bitmap, such as a pointer, a LUT, or the like) may be used, in order to provide such association for the cell-specific report configurations for the source and target cells. Moreover, it is to be noted that, as exemplarily shown in FIG. 2, the RRC reconfiguration message may also comprise, among others, the CSI resource configuration that has been modified by the source DU in step S208. As can be understood and appreciated by the skilled person, the modification may include, but not limited to, coding and/or encapsulating the CSI resource configuration (prepared by the target DU or CU) into a different format, form or data structure (e.g, the “CellGroupConfig” as shown in step S208), depending on various implementations.

Further, steps S210 and S213 generally describe two options/possibilities (that may be used together or as alternatives, depending on various implementations and/or requirements) to support the sending of the consolidated TCI state configurations for the ICBM operation, either as the whole set of cells (step S210) or a subset thereof (step S213) which is generally decided by the (present or even potential future) source/serving DU, depending on various implementations and/or requirement (e.g., the distance between two cells, the received signal power, etc.). For instance, in some possible implementations, the decision to send an indication on a subset of the cells in the TCI state configuration may be determined based on the measurement (e.g., a layer 1/L1 measurement, such as the reference signal received power (RSRP) or the like) as shown in step S212 where the UE uses the serving cell reporting configuration for sending the respective report (step S211). As an illustrative example (but not as a limitation of any kind), assuming that a total of 5 cells (referenced by using numbers 1 to 5) are involved or participating in the ICBM and that cell 1 is currently serving as the source cell (thus cells 2 to 5 are target cells for the moment), the source DU (of cell 1) may (e.g., depending on the measurement report such L1-RSRP from the UE) decide to switch to cell 2 (current target cell). At this time, the source DU may further determine (e.g., from said measurement report or by using any other suitable means) that cells 3 and 4 appear to be in close vicinity of cell 2 (such that once cell 2 becomes the “source cell” after the current beam switching operation, cells 3 and 4 may be considered as potential “target cells” by then). As a result, the current source DU (of cell 1) may select and prepare to send an indication on a subset of cells from the total 5 cells (in the present illustrative example, that would be cells 2, 3 and 4) in the TCI state configuration to the target DU (of the current target cell, i.e., cell 2 in the present illustrative example). Of course, as can be understood and appreciated by the skilled person, any other suitable implementations may be adopted as well, depending on various circumstances. In some possible implementations, a normal F1 procedure (e.g., UE context modification request from the serving DU to CU-CP (central unit control plane) and UE context modification request from CU-CP to target DU) can be used here. Alternatively, in some other possible implementations, control PDUs indicating indexes of previously shared TCI state configurations may also be used. Of course, any other suitable (existing or new) procedure(s)/process(es) may be used as well, as can be understood and appreciated by the skilled person.

Subsequently, in steps S214-S215, particularly as the TCI state switch to the target cell is indicated (e.g., in the MAC CE as exemplified in step S214), the UE switches using the bitmap updated report configuration but continues to use the erstwhile “merged” CSI resource configuration as described above (step S215). Notably, as can be understood and appreciated by the skilled person, in some possible implementations, the UE may for example be configured with measurement configurations related to one or more beams in the target cell, such that depending on the measurement report (e.g., in step S212, performed for one or more beams), the TCI state change information/message in step S214 may indicate a specific beam in the target cell for the UE to switch onto.

In steps S216-S218, in case the UE would switch back to the source cell (which is supported by the “dynamic switching” feature enabled in step S205 earlier), the UE may perform such a switch by using the bitmap updated report configuration but continue to use the erstwhile “merged” CSI resource configuration now based on the source cell instead of the target cell. To be more specific, as shown in the example of FIG. 2, the UE switches its monitoring of the control channel (e.g., PDCCH (physical downlink control channel) or the like) from the source cell to the target cell (step S216) and reports in step S217—similar to above—a L1-RSRP (or in any other suitable form) measurement by using the uplink resources (e.g., PUSCH (physical uplink shared channel), PUCCH (physical uplink control channel), or the like) of the target cell to the target DU (of the target cell), but this time indicates the earlier source cell as a potential target cell (e.g., with better signal). In response to that measurement report, the target DU may send, in step S218, a corresponding message indicative of a TCI state change corresponding to the earlier source cell, or in some possible implementations, to a specific beam of the earlier source cell (e.g., by using a MAC CE or the like). And as a result, the UE switches back to the CSI report configuration of the earlier source cell as before.

To summarize the above, the example embodiments as described with reference to FIGS. 1 and 2 may generally be seen as to propose to use cell specific report configurations within the CSI measurement configuration (but the resource configuration is maintained as common among all cells) and short TCI sub-set maintenance for ICBM operations. To be more specific, compared to conventional techniques, there may be the following new aspects (that are applied for optimizing the signaling for supporting ICBM) that are worth mentioning. Firstly, a CU (e.g., a gNB-CU-CP) may consolidate the CSI configurations of all ICBM/dynamic switching participating cells in a single configuration containing parts applicable for the specific serving cell and parts which are applicable commonly for all the cells (or a subset thereof) participating in ICBM. Secondly, the UE may select a subset of CSI report configuration for the L1-RSRP reporting based on the current serving cell of the UE. Thirdly, inter-node (inter-DU) coordination is proposed to enable different CSI reporting configurations at the target cell as part of the preparation for ICBM operation. Particularly, this is about the coordination and communication between the serving DU and the target DU via the CU-CP to configure ICBM/dynamic switching at UE and network sides. Last but not least, further inter-node (inter-DU) coordination is proposed to provide a subset of TCI states which are potential TCI state(s) for switching to the target cell prior to beam switching to the new cell. In other words, this is about relaying the necessary information (from target DU via CU-CP) to the serving DU to enable inter-DU ICBM/dynamic switching at the serving DU.

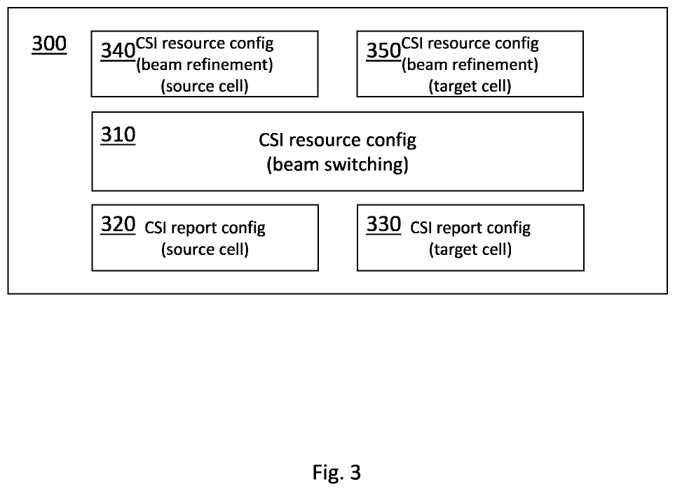

References are now made to FIGS. 3 to 5, which schematically describes some further example embodiments that may (depending on various implementations) be used in conjunction with (at least partially) or as an alternative to the example embodiments as described with reference to FIGS. 1 to 2.

Particularly, FIG. 3 schematically illustrates another example implementation of a high-level block diagram of a CSI (channel state information) measurement(-related) configuration.

In a broad sense, the example embodiment as shown in FIG. 3 may generally be seen as to implement a (modified as compared to existing techniques) CSI resource configuration and report configuration within the CSI measurement configuration but with a classification of configurations for beam operation modes (e.g., beam refinement, beam switching, etc.).

To be more specific, as represented in FIG. 3, the CSI resource configuration set is now divided into three (sub-)sets, namely one set 310 for purposes of beam switching across all cells participating in the ICBM operation (similar to block 110 as shown in FIG. 1); and two sets 340 and 350 for (source) cell specific beam refinement related resource configurations. On the other hand, similar to those shown in FIG. 1, the CSI measurement configuration 300 may also comprise (source) cell-specific CSI report related configurations (at least) for the source cell 320 and for the (potential) target cell(s) 330, respectively. That is to say, the report configurations are (source) cell specific and point to any of the resource sets (e.g., by using a bitmap as described in FIG. 2 or in any other suitable manner).

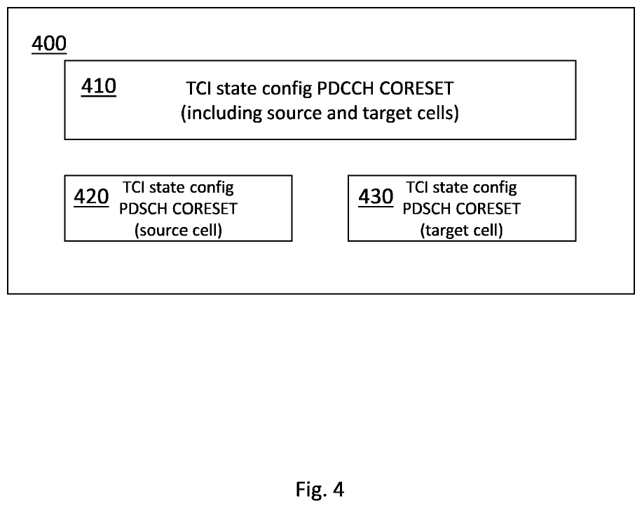

Furthermore, in contrast to the example embodiments of FIGS. 1 and 2 (where the TCI state configurations are generally transmitted/selected by the source DU), FIG. 4 further schematically illustrates an example of a high level block diagram of a modified TCI state configuration that could be used.

To be more specific, as shown in FIG. 4, the (overall) TCI state configuration 400 may be modified to also comprise cell specific and common parts. Here, the “cell-specific” and “common” TCI state configurations are to be understood in an analogous or similar manner to that has been described above with respect to for example CSI report related configurations. More particularly, there is provided a TCI state configuration 410 of the control channel resources (such as the PDCCH, or specifically the PDCCH CORESET (control resource set)) that is commonly referred to in all the cells (or a part thereof) of the ICBM (including, but not limited to, the TCI states for the source and target cells). In addition thereto, there is also provided a (source) cell-specific TCI state configuration 420 of the data channel resources (such as the PDSCH, or specifically the PDSCH CORESET) specifically for the source cell and a cell-specific TCI state configuration 430 of the data channel resources (such as the PDSCH, or specifically the PDSCH CORESET) specifically for the target cell. As has been illustrated above, depending on various implementations, in cases of multiple target cells configured for the ICBM operation, there may be more than one instance of such cell-specific TCI state configuration for the target cells.

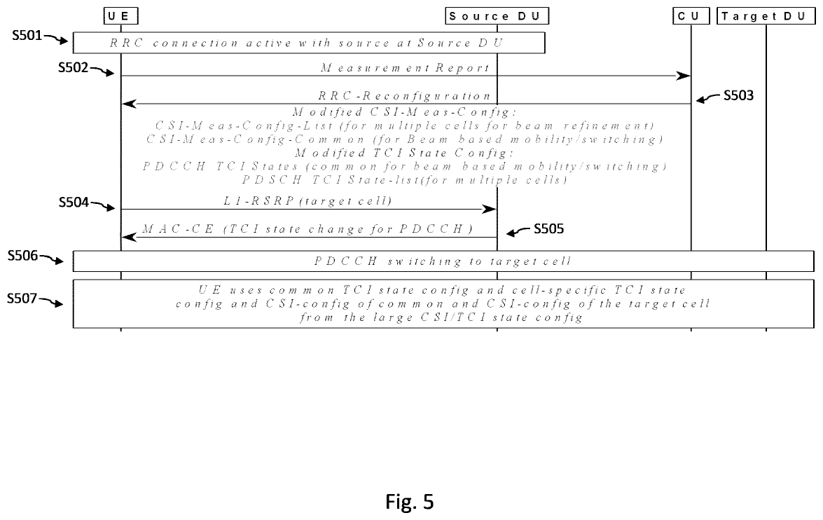

Now, a message sequence of the signaling procedure for configuring the UE with modified CSI-Measurement configuration and TCI state configuration will be described in more detail below with reference to FIG. 5. Similar to illustrated above, in the example embodiment of FIG. 5, it is generally assumed that the source cell resides at the source DU (or in other words, under the control of the source DU), whilst the (neighboring) target cell resides at the target DU (or in other words, under the control of the target DU). However, as can be understood and appreciated by the skilled person, the deployment of the source/target cells and/or the source/target DUs does not necessarily always have to be like this. For instance, in some possible implementations, both the source cell and the target cell may be under the control of the source DU alone. Certainly, any other suitable configuration may be possible as well (with appropriate adaptation to the signaling/messaging of course) depending on various implementations and/or requirements. It is further to be noted that, compared to the example embodiment of FIG. 2, it can be seen that higher layer configurations (e.g., RRC signalings) are generally not affected/modified during beam switching in the present example embodiment.

More particularly, as described above, the CSI resource configuration comprises a common configuration as well as cell specific parts (e.g., for the source and target cells). Each cell specific part comprises the beam refinement-related measurement information. But there is still only one CSI resource configuration pool for beam switching across cells. Similar to that as shown in FIG. 1, the reporting configurations are also cell specific and point to the cell specific CSI resource configuration.

Specifically, similar to above, in steps S501 and S502, the UE is connected to a source cell (or simply referred to as cell 1, not explicitly shown in the figure) which is under the control of the source DU and reports (among others) a target cell (or simply referred to as cell 2) in its measurements to the CU.

Further, similar to step S209 of FIG. 2, in step S503, the CU prepares an RRC reconfiguration message (or any other suitable message depending on various implementations), but this time with the modified CSI measurement configuration and the modified TCI state configuration.

Subsequently, similar to step S212 of FIG. 2, in step S504, the UE uses the serving cell reporting configuration for sending the L1 RSRP report (or in any other suitable form) to the source DU, indicating the target cell (cell 2) as a potential “strong” cell.

In response to that measurement report, the source DU sends, in step S505 (similar to step S214 of FIG. 2), a suitable MAC CE indicating the TCI state change for the control channel (e.g., PDCCH or the like) to the target cell. As a result, the UE switches its monitoring of the control channel (e.g., PDCCH or the like) from the source cell to the target cell similar to step S216 of FIG. 2. From then on, as shown in step S507, the UE may start using the common CSI configuration and TCI state configuration as well as the cell-specific CSI configuration and TCI state configuration of the target cell.

It may be worthwhile to note that, although not explicitly shown in the figure, the example embodiment of FIG. 5 may also implement the “dynamic switching” (e.g., switching from cell 2 back to cell 1) as described above.

It may be worthwhile to further note that, in some possible implementations, the concept/idea of determining/selecting a subset of TCI state configurations (as described with reference to step S213 of FIG. 2) may be adopted in the example embodiment of FIG. 5 as well (i.e., on top of the proposed classification of TCI state configurations), possibly with suitable adaptations and/or modifications wherever appropriate, thereby further reducing the TCI state configurations that need to be communicated between network nodes in order to support the ICBM operation.

To summarize the above, the example embodiments as described with reference to FIGS. 3 to 5 may generally be seen as to propose a classification of beam refinement and beam switching configurations for the CSI measurement configuration and TCI state switching. To be more specific, compared to conventional techniques, there may be the following new aspects (that are applied for optimizing the signaling for supporting ICBM) that worth mentioning. Firstly, it is proposed a modification to CSI-RS resource configuration within CSI Measurement configuration to include additional information to identify CSI-RS resources for beam refinement and CSI-RS resources for beam switching within the configuration. In other words, the ICBM/dynamic switching CSI measurement configuration may be seen to include both serving DU and target DU cells selected for ICBM/dynamic switching. Secondly, a new field may be introduced in the CSI resource configuration for example with cell-ID for supporting beam refinement resources. In some other possible implementations, cell specific bitmap may be implemented to identify the cell specific beam refinement resources. Thirdly, beam switching resources are applicable in all the serving cells which are part of ICBM. On the other hand, beam refinement configurations applicable for the serving cell are used. Fourthly, for PDSCH TCI state configuration which is one example for beam refinement configuration, cell specific identification may be included from the DU to the UE. Last but not least, the UE may switch its CSI measurement operation to the subset of configuration applicable for current ICBM cell from the “super-set” of CSI-measurement configuration which is considered as a container for all serving cell CSI measurement configurations.

It is noted that, although in the above-illustrated example embodiments (with reference to the figures), the messages communicated/exchanged between the network components/elements may appear to have specific/explicit names, depending on various implementations (e.g., the underlining technologies), these messages may have different names and/or be communicated/exchanged in different forms/formats, as can be understood and appreciated by the skilled person.

According to some example embodiments, there are also provided corresponding methods suitable to be carried out by the apparatuses (network elements/components) as described above, such as the UE, the CU, the DU, etc.

It should nevertheless be noted that the apparatus (device) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the UE, the CU, the DU, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

Yet in some other example embodiments, there is provided a respective apparatus (e.g., implementing the UE, the CU, the DU, etc., as described above) that comprises respective means configured to at least perform the respective steps as described above.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

It should also to be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiment outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

1-31. (canceled)

32. A user equipment, UE, configured for supporting inter-cell beam management, ICBM, involving a plurality of cells which includes a source cell serving the UE and at least one neighboring target cell, wherein the UE comprises:
at least one processor; and
at least one memory storing instructions that, when executed by the at least one processor, cause the UE at least to:
send a measurement report comprising information indicative of a target cell of the at least one neighboring target cell to a first network node that supports at least one of central unit control plane, CU-CP, functionality or a layer 3 protocol of a radio access network; and
receive, from the first network node, a configuration message comprising information indicative of a channel state information, CSI, measurement related configuration, wherein the CSI measurement related configuration comprises a CSI resource related configuration that is commonly used for measurement at cells involved in the ICBM and a cell-specific CSI report related configuration for a subset of the cells, wherein the subset is determined depending on the source cell, and wherein the subset includes the source cell and at least one the target cell.

33. The UE according to claim 32, wherein the UE is further caused to:
perform a measurement based on the CSI measurement related configuration; and
report a result of the measurement to a second network node of the source cell that supports at least one of distributed unit, DU, functionality or the layer 2 protocol of the radio access network based on the CSI report related configuration corresponding to the source cell.

34. The UE according to claim 32, wherein the UE is further caused to:
receive, from the second network node of the source cell, a message indicative of a transmission configuration indication, TCI, state corresponding to the target cell, for switching the UE to a beam of the target cell indicated by the TCI state.

35. The UE according to claim 32, wherein the UE is further caused to:
switch control channel monitoring from the source cell to the target cell.

36. The UE according to claim 32, wherein the UE is further caused to:
perform a measurement based the CSI measurement related configuration, and report a result thereof to a second network node of the target cell that supports at least one of distributed unit, DU, functionality or the layer 2 protocol of the radio access network based on the CSI report related configuration corresponding to the target cell.

37. The UE according to claim 32, wherein the UE is further caused to:
receive, from the second network node of the target cell, a message indicative of a TCI state corresponding to the source cell, for switching the UE back to a beam of the source cell indicated by the TCI state.

38. The UE according to claim 36, wherein the second network node of the source cell and the second network node of the target cell are different network nodes.

39. The UE according to claim 32, wherein the CSI resource related configuration commonly used for measurements at cells is for beam switching; and wherein the CSI measurement related configuration further comprises a cell-specific CSI resource related configuration for beam refinement for the subset of cells.

40. The UE according to claim 39, wherein the configuration message further comprises a control channel related TCI state configuration that is commonly referred to in cells involved in the ICBM and a cell-specific data channel related TCI state configuration for the subset of cells.

41. The UE according to claim 32, wherein the configuration message further comprises a cell-specific bitmap associated with the cell-specific CSI report related configuration for the subset of cells.

42. The UE according to claim 32, wherein the configuration message is a radio resource control, RRC, reconfiguration message.

43. A first network node that supports at least one of central unit control plane, CU-CP, functionality or a layer 3 protocol of a radio access network, configured for supporting inter-cell beam management, ICBM, involving a plurality of cells which includes a source cell serving a user equipment, UE, and at least one neighboring target cell, wherein the first network node comprises:
at least one processor; and
at least one memory storing instructions that, when executed by the at least one processor, cause the first network node at least to:
receive, from the UE, a measurement report comprising information indicative of a target cell of the at least one neighboring target cell;
generate a configuration message comprising information indicative of a channel state information, CSI, measurement related configuration, wherein the CSI measurement related configuration comprises a CSI resource related configuration that is commonly used for measurement at cells involved in the ICBM and a cell-specific CSI report related configuration for a subset of the cells, wherein the subset is determined depending on the source cell, and wherein the subset includes the source cell and at least one target cell; and
send the configuration message to the UE.

44. The first network node according to claim 43, wherein the first network node is further caused to:
transmit a first request message comprising information indicative of ICBM to a second network node of the source cell that supports at least one of distributed unit, DU, functionality or the layer 2 protocol of the radio access network; and
receive, from the second network node of the source cell, a first response message comprising information indicative of the CSI resource related configuration.

45. The first network node according to claim 43, wherein the first network node is further caused to:
transmit a second request message comprising information indicative of ICBM and information indicative of the CSI resource related configuration to a second network node of the target cell that supports at least one of distributed unit, DU, functionality or the layer 2 protocol of the radio access network; and
receive, from the second network node of the target cell, a second response message comprising information indicative of CSI measurement related configuration for the target cell.

46. The first network node according to claim 43, wherein the first network node is further caused to:
transmit a third request message comprising information indicative of the CSI measurement related configuration for the target cell to the second network node of the source cell; and
receive, from the second network node of the source cell, a third response message comprising information indicative of the CSI measurement related configuration modified based on the information indicative of the CSI measurement related configuration for the target cell.

47. The first network node according to claim 43, wherein the first and second request messages are each a respective UE context setup request message; and the first and second response messages are each a respective UE context setup response message.

48. The first network node according to claim 43, wherein the third request message is a UE context modification request message; and the third response message is a UE context modification response message.

49. The first network node according to claim 43, wherein the CSI resource related configuration commonly used for measurements at cells is for beam switching; and wherein the CSI measurement related configuration further comprises a cell-specific CSI resource related configuration for beam refinement for the subset of cells.

50. The first network node according to claim 49, wherein the configuration message further comprises a control channel related transmission configuration indication, TCI, state configuration that is commonly referred to in cells involved in the ICBM and a cell-specific data channel related TCI state configuration for the subset of cells.

51. The first network node according to claim 43, wherein the configuration message further comprises a cell-specific bitmap associated with the cell-specific CSI report related configuration for the subset of cells.

52. The first network node according to claim 43, wherein the configuration message is a radio resource control, RRC, reconfiguration message.

53. A second network node that supports at least one of distributed unit, DU, functionality or a layer 2 protocol of a radio access network, configured for supporting inter-cell beam management, ICBM, involving a plurality of cells which includes a source cell of the second network node serving a user equipment, UE, and at least one neighboring target cell, wherein the second network node comprises:
at least one processor; and
at least one memory storing instructions that, when executed by the at least one processor, cause the second network node at least to:
receive, from a first network node that supports at least one of central unit control plane, CU-CP, functionality or the layer 3 protocol of the radio access network, a first request message comprising information indicative of a channel state information, CSI, measurement related configuration for a target cell of the at least one neighboring target cell;
generate a first response message comprising information indicative of a CSI measurement related configuration modified based on the received information indicative of the CSI measurement related configuration for the target cell, wherein the CSI measurement related configuration comprises a CSI resource related configuration that is commonly used for measurement at cells involved in the ICBM and a cell-specific CSI report related configuration for a subset of the cells, wherein the subset is determined depending on the source cell, and wherein the subset includes the source cell and at least one target cell; and
send the first response message to the first network node.

54. The second network node according to claim 53, wherein the second network node is further caused to:
receive, from the first network node, a second request message comprising information indicative of ICBM; and
transmit a second response message comprising information indicative of the CSI resource related configuration to the first network node.

55. The second network node according to claim 53, wherein the second network node is further caused to:
transmit a configuration message that comprises information indicative of transmission configuration indication, TCI, state information for the cells involved the ICBM.

56. The second network node according to claim 53, wherein the second network node is further caused to:
receive, from the UE, a report of a measurement performed based on the CSI report related configuration corresponding to the source cell; and
transmit a configuration message that comprises information indicative of TCI state information for another subset of the cells involved the ICBM, wherein the another subset of the cells is determined based on the target cell.

57. The second network node according to claim 53, wherein the second network node is further caused to:
transmit a message indicative of a transmission configuration indication, TCI, state corresponding to the target cell to the UE, for switching the UE to a beam of the target cell indicated by the TCI state.

58. The second network node according to claim 53, the first request message is a UE context modification request message; and the first response message is a UE context modification response message.

59. The second network node according to claim 53, wherein the second request message is a UE context setup request message; and the first response message is a UE context setup response message.
